(19) United States
(12) Patent Application Publication
(10) Pub. No.: US 2013/0343741 A1
(43) Pub. Date: Dec. 26, 2013

(54) USER CONTROL OF FLASH LIGHT CHARACTERISTICS IN A CAMERA SYSTEM

(71) Applicant: Sachin Krishna Nikam, Pune (IN)

(72) Inventor: Sachin Krishna Nikam, Pune (IN)

(73) Assignee: NVIDIA Corporation, Santa Clara, CA (US)

(21) Appl. No.: 13/528,884

(22) Filed: Jun. 21, 2012

(51) Int. Cl. G03B 15/05

(52) U.S. Cl. 396/164; 396/155

(57) ABSTRACT

A method includes providing, in a camera system, a flash light including one or more Light Emitting Diodes (LEDs) having color changing ability based on the one or more LEDs being constituted by a combination of semiconductor compounds, and providing a user interface on the camera system to enable a user of the camera system to modify a number of settings on the camera system. The method also includes modifying, through a flash light driver component, an intensity level of the flash light and/or a voltage supplied thereto through a flash light driver circuit of the flash light in accordance with an appropriate modified setting by the user on the user interface. The modification of the voltage supplied to the flash light enables an appropriate modification of a color of a light emitted by the flash light.

### FIELD OF TECHNOLOGY

This disclosure relates generally to camera systems and, more particularly, to a method, an apparatus and/or a system of user control of flash light characteristics in a camera system.

### BACKGROUND

A camera system (e.g., a digital camera, a mobile phone with a camera, a laptop with a camera, a desktop Personal Computer (PC) with a camera) may provide for white light being emitted from a flash thereof when the camera therein is clicked. When a user of the camera system desires a specific color of a background environment of the camera system for taking pictures and/or shooting videos, he/she may have to utilize an additional source of light corresponding to the specific color. The aforementioned additional source of light may be cumbersome to carry/install and/or may be an additional expense. Further, the process associated with the capturing of images and/or the shooting of videos may be inefficient when the additional source of light is used. In addition, the user may have to perform post-processing of the captured images and/or the videos in order to achieve desired effects thereon.

### SUMMARY

Disclosed are a method, an apparatus and/or a system of user control of flash light characteristics in a camera system.

In one aspect, a method includes providing, in a camera system, a flash light including one or more Light Emitting Diodes (LEDs) having color changing ability based on the one or more LEDs being constituted by a combination of semiconductor compounds, and providing a user interface on the camera system to enable a user of the camera system to modify a number of settings on the camera system. The method also includes modifying, through a flash light driver component, an intensity level of the flash light and/or a voltage supplied thereto through a flash light driver circuit of the flash light in accordance with an appropriate modified setting by the user on the user interface. The modification of the voltage supplied to the flash light enables an appropriate modification of a color of a light emitted by the flash light.

In another aspect, a camera system includes a flash light having one or more LEDs with color changing ability based on the one or more LEDs being constituted by a combination of semiconductor compounds, a user interface to enable a user of the camera system to modify a number of settings thereon, a flash light driver circuit of the flash light, and a flash light driver component. The flash light driver component is specific to an application enabling the user to modify the number of settings on the camera system, and is configured to modify an intensity level of the flash light and/or a voltage supplied thereto through the flash light driver circuit in accordance with an appropriate modified setting by the user on the user interface. The modification of the voltage supplied to the

flash light enables an appropriate modification of a color of a light emitted by the flash light.

In yet another aspect, a camera system includes a flash light having one or more LEDs with color changing ability based on the one or more LEDs being constituted by a combination of semiconductor compounds, a user interface to enable a user of the camera system to modify a number of settings thereon, a flash light driver circuit of the flash light, an operating system loaded in a memory of the camera system, and a flash light driver component integrated with the operating system. The flash light driver component is configured to modify an intensity level of the flash light and/or a voltage supplied thereto through the flash light driver circuit in accordance with an appropriate modified setting by the user on the user interface. The modification of the voltage supplied to the flash light enables an appropriate modification of a color of a light emitted by the flash light.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a camera system including a flash light, according to one or more embodiments.

FIG. 2 is a table of example characteristics of a Light Emitting Diode (LED) utilized in the flash light of the camera system of FIG. 1.

FIG. 3 is a schematic view of an example user interface on the camera system of FIG. 1.

FIG. 4 is a schematic view of the example user interface of FIG. 3 showing options associated with an intensity of the flash light of FIG. 1.

FIG. 5 is a schematic view of interaction between a flash light driver component and the flash light of FIG. 1 during modification of the intensity thereof and/or the voltage supplied thereto.

FIG. 6 is a process flow diagram detailing the operations involved in a method of control of the flash light of the camera system of FIG. 1.

Other features of the present embodiments will be apparent from the accompanying drawings and from the detailed description that follows.

### DETAILED DESCRIPTION

Example embodiments, as described below, may be used to provide a method, a system and/or an apparatus of user control of flash light characteristics in a camera system. Although the present embodiments have been described with reference to specific example embodiments, it will be evident that various modifications and changes may be made to these embodiments without departing from the broader spirit and scope of the various embodiments.

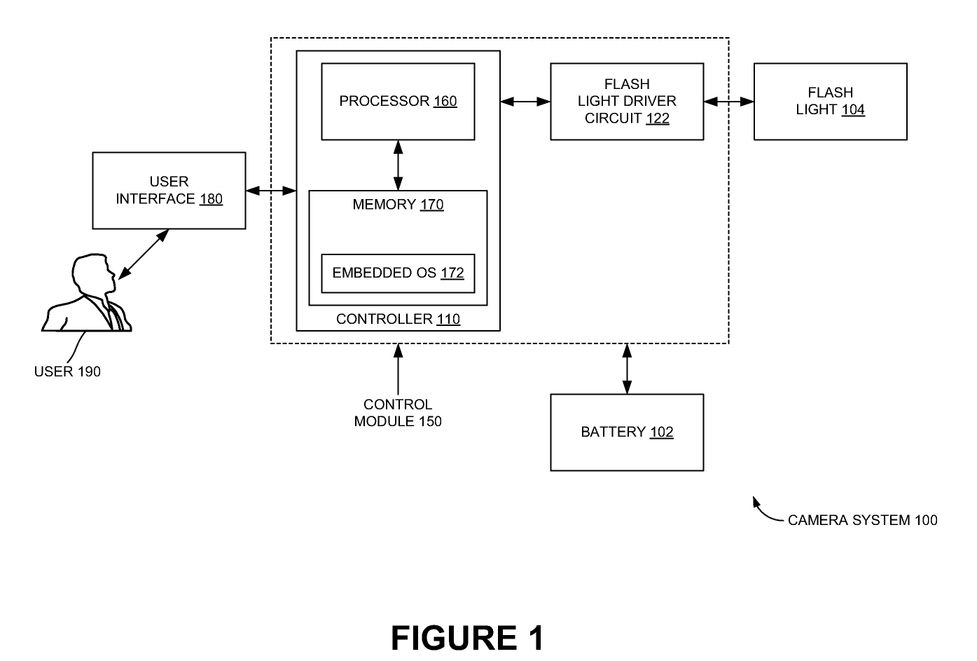

FIG. 1 shows a block diagram of a camera system 100, according to one or more embodiments. In one or more embodiments, camera system 100 may be a portable device (e.g., a mobile phone) or even a laptop, a desktop Personal Computer (PC) and the like including a digital camera. Alternately, in one or more embodiments, camera system 100 may solely be a digital camera (e.g., still camera, video camera). In one or more embodiments, camera system 100 may include a controller 110 (e.g., a dedicated integrated circuit (IC) residing in camera system 100 including a processor 160 and/or a memory 170) configured to control functionalities associated with camera system 100.

In one or more embodiments, memory 170 shown in FIG. 1 may include storage locations configured to be addressable through processor 160. In one or more embodiments, an embedded operating system (e.g., embedded OS 172) may execute on data processing system 100. FIG. 1 shows operating system (e.g., embedded OS 172) instructions as being stored in memory 170. Embedded operating system(s) (e.g., Windows® Embedded Compact (WinCE), Palm OS®, Android™, Apple®'s iOS®) may be preferentially utilized in exemplary embodiments when camera system 100 is a mobile phone. Also, it is obvious that non-embedded operating system(s) may execute on camera system 100 when camera system 100, for example, is a laptop or a desktop PC. Further, it is obvious that operating system(s) (e.g., embedded OS 172) may not even be required when camera system 100 is a digital camera.

FIG. 1 shows controller 110 as being configured to manage flash light driver circuit 122 that is configured to modify the intensity of a flash light 104 and/or a voltage supplied thereto based on a control signal from controller 110. Also, controller 110 is shown along with flash light driver circuit 122 as being part of a control module 150 configured to control flash light 104 (e.g., a Light Emitting Diode (LED)). In one or more embodiments, control module 150 may be a dedicated integrated circuit that is programmable.

In one or more embodiments, as data processing system 100 may be configured to derive power from a battery 102, battery 102 is shown as being interfaced with control module 150. It is obvious that control module 150 may include other elements necessary for the functioning of camera system 100 but not relevant to the concepts associated with the exemplary embodiments discussed herein. Therefore, discussion associated with the aforementioned other elements have been skipped for the sake of clarity and convenience.

In one or more embodiments, camera system 100 may include a user interface 180 coupled to controller 110 in order to enable a user 190 of camera system 100 to input options associated with the intensity control of flash light 104 and/or the voltage supplied to flash light 104. In one or more embodiments, the color of flash light 104 may depend on the semiconductor material utilized in flash light 104 (e.g., LED device) and the voltage supplied thereto. For example, user 190 of camera system 100 may want a specific colored light from flash light 104 in order to create a desired ambience/environment for taking a picture/shooting a video. Therefore, in one or more embodiments, flash light 104 may include one or more LEDs having color changing ability and being constituted by a combination of material(s). In one or more embodiments, controller 110 may be programmed to alter a voltage supplied to flash light 104 in order to alter the color of light emitted from flash light 104.

LEDs may be manufactured from semiconductor compounds such as Gallium Arsenide (GaAs), Gallium Phosphide (GaP), Gallium Arsenide Phosphide (GaAsP), Silicon Carbide (SiC), Gallium Indium Nitride (GaInN) and Aluminum Gallium Phosphide (AlGaP), a number of which is mixed together at different ratios to produce a distinct color wavelength corresponding to a voltage applied to flash light 104. The aforementioned semiconductor compounds may emit light in specific regions of the visible light spectrum, and, therefore, produce different intensity levels of light therefrom. The exact choice of semiconductor material used in forming a P-N junction may, thus, determine the wavelength of photon light emissions and, thereby, the resulting color of the light emitted.

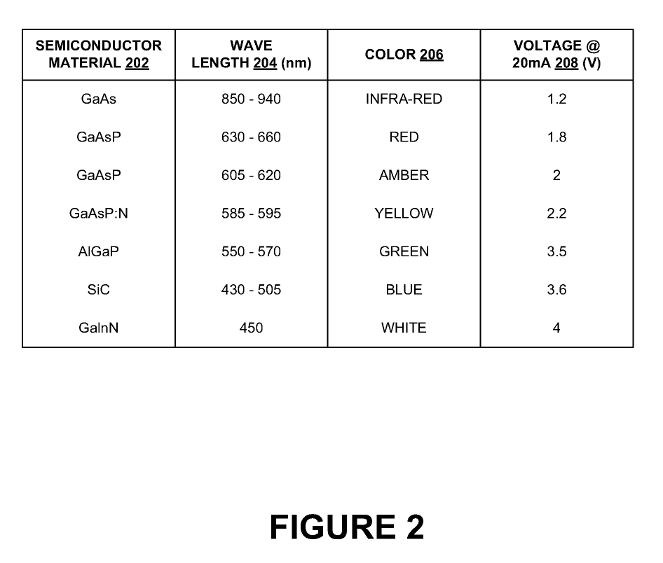

FIG. 2 shows example characteristics of an LED utilized in flash light 104. FIG. 2 shows wavelength 204 of light emitted for a particular semiconductor material 202 when a specific voltage 208 is applied to the LED at 20 mA current. Further, color 206 of the light emitted from the LED for the particular semiconductor material 202 is also shown. Although, coloring of the plastic body of an LED may be done to provide an approximate effect, the coloring is utilized more to indicate the color (of the light to be emitted upon an appropriate voltage being applied thereto) of the LED when not in use.

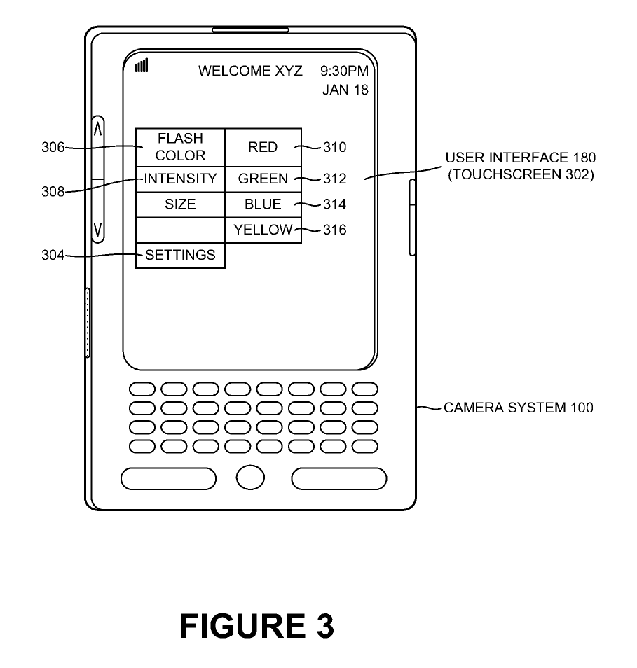

FIG. 3 shows example user interface 180 of camera system 100, according to one or more embodiments. In the aforementioned example FIG. 3, camera system 100 is a mobile phone and user interface 180 is a touchscreen 302. When user 190 of camera system 100 desires a change in the color of flash light 104, he/she may access camera settings 304 on touchscreen 302 and access the appropriate available options (e.g., flash color 306 having Red 310, Green 312, Blue 314 and Yellow 316 as options). It is obvious that there may be other color options available to user 190. Moreover, it is obvious that user 190 may be provided voltage options (not shown) to modify (or, indirectly modify voltage to flash light 104) instead of the aforementioned color options. The aforementioned variations (and analogous variations) are within the scope of the exemplary embodiments.

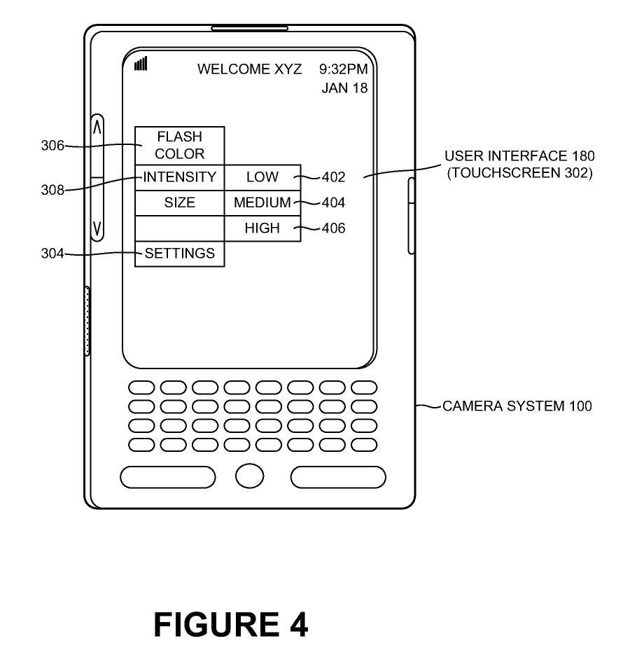

FIG. 3 also shows camera settings 304 as having options to modify flash intensity 308. FIG. 4 shows example user interface 180 of camera system 100 as showing options associated with flash intensity 308. Thus, when user 190 desires a modification of the intensity of flash light 104, he/she may access camera settings 304 and access the options associated with flash intensity 308. Example options associated with flash intensity 308 are low 402, medium 404 and high 406. It is obvious that the intensity of flash light 104 may be controlled to appropriate levels in accordance with the choice of one of the aforementioned options. Variations in the options are within the scope of the exemplary embodiments.

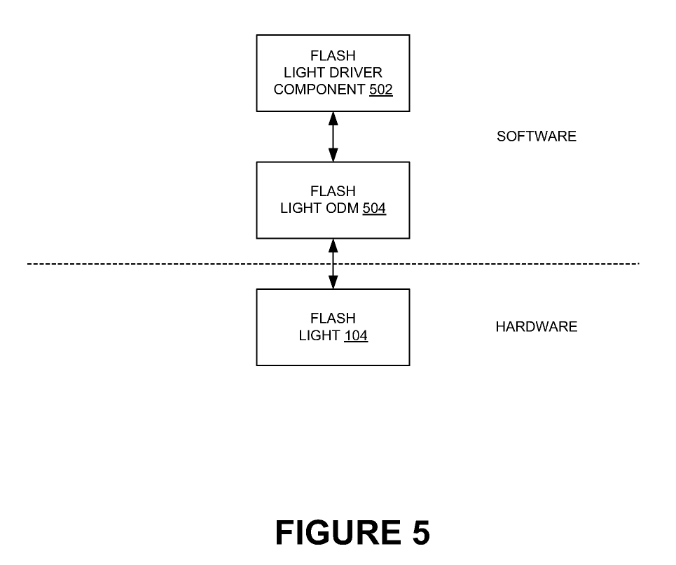

FIG. 5 shows interaction between a flash light driver component 502 and flash light 104 during modification of the intensity of flash light 104 and/or the voltage supplied thereto. In one or more embodiments, an Original Design Manufacturer (ODM) associated with data processing system 100 may define intensity levels of flash light 104 and/or voltage levels applied thereto (e.g., shown as flash light ODM 504). For example, three ranges of intensity levels may be defined as discussed above, viz., low 402, medium 404 and high 406. Also, for example, voltages levels for a number of colors of light to be emitted from flash light 104 may be defined (e.g., Red 310, Green 312, Blue 314 and Yellow 316, as discussed above).

In an example embodiment, whenever user 190 desires to modify intensity levels of flash light 104 and/or voltage levels applied thereto, user 190 may access user interface 180 as discussed with regard to FIG. 3 and FIG. 4. As soon as user 190 selects the appropriate color or intensity level, flash light driver component 502 (e.g., a software driver of flash light 104) may control flash light driver circuit 122 through controller 110 to modify the voltage supplied to flash light 104 or the intensity level output from flash light 104 appropriately based on the ODM levels. For example, through the action of selecting options by user 190, a driver routine may be invoked such that flash light driver component 502 may issue appropriate command(s)/signal(s) to flash light 104. Thus, flash light driver component 502 may be application specific. In other words, flash light driver component 502 may be specific to the application enabling user 190 to modify settings on camera system 100.

Thus, flash light driver component 502, in conjunction with flash light driver circuit 122, may modify the intensity of flash light 104 and/or voltage applied thereto in accordance with the input from user 190. Alternately, user interface 180 may be a multi-way switch configured to be operated by user 190 to modify the intensity level of flash light 104 and/or the voltage applied thereto. Other forms of user interface 180 are within the scope of the exemplary embodiments. In one or more embodiments, when camera system 100 includes embedded OS 172 or a non-embedded OS, the intensity level modification and/or the voltage level modification functionalities may also be enabled and/or disabled through the registry settings associated therewith.

Thus, exemplary embodiments discussed above dispense with a need for an additional light source to provide for ambient light during shooting pictures/videos with camera system 100. This, in addition to the intensity level modification functionality, may reduce or dispense with post-processing requirements of images and/or videos captured through camera system 100.

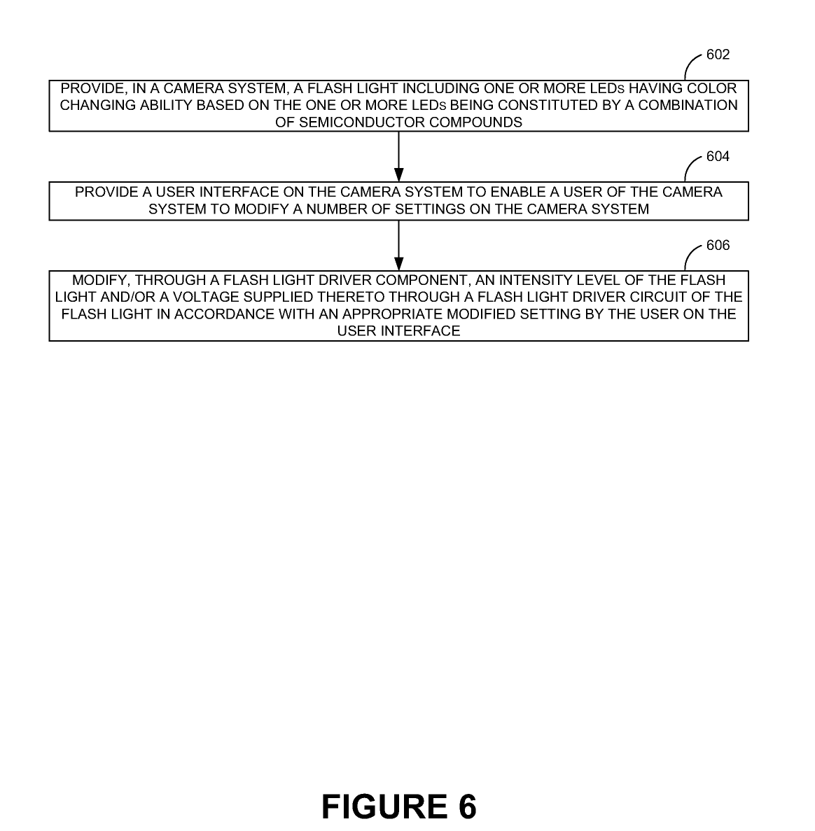

FIG. 6 shows a process flow diagram detailing the operations involved in a method of control of flash light 104 of camera system 100, according to one or more embodiments. In one or more embodiments, operation 602 may involve providing, in camera system 100, flash light 104 including one or more LEDs having color changing ability based on the one or more LEDs being constituted by a combination of semiconductor compounds. In one or more embodiments, operation 604 may involve providing user interface 180 on camera system 100 to enable user 190 of camera system 100 to modify a number of settings on camera system 100.

In one or more embodiments, operation 606 may then involve modifying, through flash light driver component 502, an intensity level of flash light 104 and/or a voltage supplied thereto through flash light driver circuit 122 of flash light 104 in accordance with an appropriate modified setting by user 190 on user interface 180. In one or more embodiments, the modification of the voltage supplied to flash light 104 may enable an appropriate modification of a color of a light emitted by flash light 104.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer device). Accordingly, the specification and drawings are to be regarded in an illustrative rather than a restrictive sense.

1. A method comprising:
providing, in a camera system, a flash light comprising a Light Emitting Diode (LED) having color changing ability based on the LED being constituted by a combination of semiconductor compounds mixed together at different ratios to produce a distinct color wavelength corresponding to a voltage supplied to the flash light;
providing a user interface on the camera system to enable a user of the camera system to modify a plurality of settings on the camera system; and
modifying, through a flash light driver component, at least one of an intensity level of the flash light and the voltage supplied thereto through a flash light driver circuit of the flash light in accordance with an appropriate modified setting by the user on the user interface, the modification of the voltage supplied to the flash light enabling an appropriate modification of a color of a light emitted by the flash light.

2. The method of claim 1, further comprising defining at least one of a plurality of voltage levels and a plurality of intensity levels associated with the flash light through an Original Design Manufacturer (ODM) associated with the camera system.

3. The method of claim 1, wherein the camera system includes an operating system executing thereon.

4. The method of claim 1, wherein the LED is constituted from at least two of: Gallium Arsenide, Gallium Phosphide, Gallium Arsenide Phosphide, Silicon Carbide, Gallium Indium Nitride and Aluminum Gallium Phosphide.

5. The method of claim 1, wherein the user interface is one of a touchscreen and a multi-way switch provided in the camera system.

6. The method of claim 1, further comprising:
invoking, in accordance with the appropriate modified setting on the user interface, a routine of the flash light driver component; and
signaling to the flash light through the flash light driver component to modify the at least one of the intensity level of the flash light and the voltage supplied thereto based on the invoked routine.

7. The method of claim 3, further comprising:
at least one of enabling and disabling a functionality associated with the modification of the at least one of the intensity level of the flash light and the voltage supplied thereto through at least one registry setting associated with the operating system.

8. A camera system comprising:
a flash light comprising an LED having color changing ability based on the LED being constituted by a combination of semiconductor compounds mixed together at different ratios to produce a distinct color wavelength corresponding to a voltage supplied to the flash light;
a user interface to enable a user of the camera system to modify a plurality of settings thereon;
a flash light driver circuit of the flash light; and
a flash light driver component specific to an application enabling the user to modify the plurality of settings on the camera system to modify at least one of an intensity level of the flash light and the voltage supplied thereto through the flash light driver circuit in accordance with an appropriate modified setting by the user on the user interface, the modification of the voltage supplied to the flash light enabling an appropriate modification of a color of a light emitted by the flash light.

9. The camera system of claim 8, wherein the flash light driver circuit is configured to modify the at least one of the intensity level of the flash light and the voltage supplied thereto based on a corresponding at least one of a plurality of intensity levels and a plurality of voltage levels defined through an ODM associated with the camera system.

10. The camera system of claim 8, further comprising an operating system executing thereon.

11. The camera system of claim 8, wherein the LED is constituted from at least two of: Gallium Arsenide, Gallium Phosphide, Gallium Arsenide Phosphide, Silicon Carbide, Gallium Indium Nitride and Aluminum Gallium Phosphide.

12. The camera system of claim 8, wherein the user interface is one of a touchscreen and a multi-way switch provided in the camera system.

13. The camera system of claim 8,
wherein the flash light driver component signals to the flash light to modify the at least one of the intensity level thereof and the voltage supplied thereto based on a routine invoked in accordance with the appropriate modified setting on the user interface.

14. The camera system of claim 10, wherein the operating system is configured to at least one of enable and disable a functionality associated with the modification of the at least one of the intensity level of the flash light and the voltage supplied thereto through at least one registry setting associated therewith.

15. A camera system comprising:
a flash light comprising an LED having color changing ability based on the LED being constituted by a combination of semiconductor compounds mixed together at different ratios to produce a distinct color wavelength corresponding to a voltage supplied to the flash light;
a user interface to enable a user of the camera system to modify a plurality of settings thereon;
a flash light driver circuit of the flash light;
an operating system loaded in a memory of the camera system; and
a flash light driver component integrated with the operating system to modify at least one of an intensity level of the flash light and the voltage supplied thereto through the flash light driver circuit in accordance with an appropriate modified setting by the user on the user interface, the modification of the voltage supplied to the flash light enabling an appropriate modification of a color of a light emitted by the flash light.

16. The camera system of claim 15, wherein the flash light driver circuit is configured to modify the at least one of the intensity level of the flash light and the voltage supplied thereto based on a corresponding at least one of a plurality of intensity levels and a plurality of voltage levels defined through an ODM associated with the camera system.

17. The camera system of claim 15, wherein the LED is constituted from at least two of: Gallium Arsenide, Gallium Phosphide, Gallium Arsenide Phosphide, Silicon Carbide, Gallium Indium Nitride and Aluminum Gallium Phosphide.

18. The camera system of claim 15, wherein the user interface is one of a touchscreen and a multi-way switch provided in the camera system.

19. The camera system of claim 15,
wherein the flash light driver component signals to the flash light to modify the at least one of the intensity level thereof and the voltage supplied thereto based on a routine invoked in accordance with the appropriate modified setting on the user interface.

20. The camera system of claim 15, wherein the operating system is configured to at least one of enable and disable a functionality associated with the modification of the at least one of the intensity level of the flash light and the voltage supplied thereto through at least one registry setting associated therewith.
